(19) United States
(12) Patent Application Publication
(10) Pub. No.: US 2014/0103239 A1
(43) Pub. Date: Apr. 17, 2014

(54) CONSTANT BLEED VALVE

(71) Applicants: Nicholas Buccheri, Florham Park, NJ (US); Emmanuel Arceo, Bloomfield, NJ (US)

(72) Inventors: Nicholas Buccheri, Florham Park, NJ (US); Emmanuel Arceo, Bloomfield, NJ (US)

(73) Assignee: AUTOMATIC SWITCH COMPANY, Florham Park, NJ (US)

(21) Appl. No.: 13/652,743

(22) Filed: Oct. 16, 2012

(51) Int. Cl. F16K 51/00

(52) U.S. Cl. 251/149.1

(57) ABSTRACT

A valve comprising a housing defining an interior chamber; an inlet port; an outlet port; an exhaust port; an actuator that selectively allows and prevents communication between the inlet port and outlet port; and a bleed port providing communication between the inlet port and the interior chamber regardless of the position of the actuator. The housing may be surrounded by an environment that is exposed to combustibles and therefore classified as a hazardous environment. Even so, the valve may be rated for use in that environment even though the actuator may require more energy to operate than would normally be acceptable in that environment.

### CROSS REFERENCE TO RELATED APPLICATIONS

None.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to valves used to control industrial processes; and more specifically relate to electrically operated valves used to control process control valves, such as those that operate in hazardous environments.

2. Description of the Related Art

The inventions described herein may be particularly useful in valves similar to those available from Automatic Switch Company (ASCO), particularly ASCO's piezotronic valves.

U.S. Pat. No. 4,610,427 discloses “a piezoelectric control valve which is arranged midway in a passage for supplying a high-pressure fuel to a fuel injection valve, and opens and closes this passage according to expansion and contraction of a piezoelectric element laminate. The valve body of the piezoelectric control valve is slidably held in a bore into which a high-pressure fuel passage connected to the fuel injection valve and a low-pressure fuel passage communicating with a fuel storage portion are opened. An annular groove is formed on the peripheral surface of the valve body, and the high-pressure fuel passage and the low-pressure fuel passage can communicate with each other through this annular groove. A piston moving reciprocatively according to expansion and contraction of the piezoelectric element laminate is provided, and a pressure chamber is formed between the piston and the valve body. The pressure in the pressure chamber is increased and decreased by the reciprocative movement of the piston, and by this increase and decrease of the pressure in the pressure chamber, the valve body is moved to connect the high-pressure fuel passage and the low-pressure passage to each other or to disconnect these passages from each other.”

U.S. Pat. No. 5,779,218 discloses a “valve having a housing (1) and at least one sealing seat (2, 3) formed therein and one piezoelectric lamina (6) self-supportingly mounted at its first end on the housing (1) and with its second end closing or opening the sealing seat (2, 3) depending on the control voltage supplied to the lamina (6). The first end of the lamina (6) is embedded in a sealing compound (7) which, in turn is at least partially incorporated in the housing (1). The lamina (6) is thereby rigidly connected to the housing (1). While the first end of the lamina (6) is being sealed, it is fixedly held in relation to the housing (1). Consequently, the lamina (6) cannot be displaced even during a long period of operation. Subsequent adjustment is therefore unnecessary.”

U.S. Pat. No. 6,367,767 discloses a “control member for a piezo-valve having an elongated flexible element, which at one of its two axial ends has a respective sealing face on oppositely placed longitudinal side faces. The two sealing elements are a common component of a sealing body, which possesses a connecting section extending between the two sealing elements and formed integrally with same, such connecting section having an opening of the flexible element extending through it. The two sealing elements overlap the marginal section, delimiting the opening, of the flexible element and in the peripheral part of the opening engage the respectively associated longitudinal side face of the flexible element.”

U.S. Pat. No. 6,705,347 discloses a “piezoelectric valve is characterized by a unique mounting arrangement for the piezoelectric element in the valve housing. The element is elongated and has one end arranged between pressurized inlet and exhaust outlet openings in the housing. The other end of the element is encapsulated in a support member which is arranged in a recess in the housing. A second support member is connected with the piezoelectric element intermediate the ends thereof. The second support is rotatably connected with the housing. When the piezoelectric element is in an active condition, the element bends to apply a strong closing force of the first end portion against the exhaust outlet so that all of the pressure from the inlet is delivered to a working outlet of the housing. When the piezoelectric element is in an inactive condition, the first end portion closes the pressurized inlet.”

U.S. Pat. No. 7,036,525 discloses a “bleed-type proportional electromagnetic valve having an input port, output port, and ejection port is disclosed. Fluid force and pressing force, proportionate to an output pressure and a current flowing in a solenoid coil respectively, act on a bleed valve for controlling the output pressure, whereby the valve can obtain an output pressure commensurate to the flowing current by displacing the valve to a position that those forces counterbalance, wherein the valve is provided with a stop valve disposed so as to be in sliding contact with a passage between the input and output port, and in contact with or separated from a valve seat. This enable the stop valve to contact with the valve seat so as to close the input port and communicate the output port with the ejection port when controlling the output pressure to be minimum.”

U.S. Patent Application Publication No. 20090140191 discloses “a device . . . for actuating a process valve that has a first cylinder and a second cylinder, comprising at least one first control valve arrangement . . . that has at least a connector for a line to the first cylinder of the double-seat valve, an intake-air connector and an exhaust-air connector, and comprising a second control valve arrangement . . . that has at least a connector for a line to the second cylinder of the double-seat valve, a connector for an intake-air line and a connector for an exhaust-air line, wherein separate exhaust-air lines . . . are provided for the first and the second control valve arrangement . . . .”

The inventions disclosed and taught herein are directed to improved electrically operated valves for use in hazardous environments.

### BRIEF SUMMARY OF THE INVENTION

A valve comprising an inlet port; an outlet port; an actuator configured to selectively allow and prevent communication between the inlet port and the outlet port; and a bleed port providing fluid communication into the valve from the inlet port of the position of the actuator. The actuator may be housed within an interior chamber in a flow path between the inlet port and the outlet port. More specifically, the actuator may be within the interior chamber and configured to selectively move between a first position, wherein communication between the inlet port and the outlet port is prevented, and a second first position, wherein communication between the inlet port and the outlet port is allowed. The bleed port may provide fluid communication between the inlet port and the interior chamber regardless of the position of the actuator. The valve may also include an exhaust port providing fluid communication between the interior chamber and an environment surrounding the valve. The actuator may be a piezoelectric element, and may or may not require more than fifty micro joules of energy to operate. Furthermore, the environment may be classified as a hazardous environment and/or exposed to combustibles. More specifically, the environment may be classified as a hazardous environment according to an internationally recognized electric code, such as the International Electrotechnical Commission (IEC) standards or code. The bleed port facilitates the valve meeting the IEC standards, such as IEC 60079, or IEC 60079-11, even where the actuator requires more than fifty micro joules of energy to operate. Thus, the valve may be rated as intrinsically safe according to an internationally recognized electric code, or standard, such as IEC 60079, regardless of whether the actuator requires more than fifty micro joules of energy to operate or not. The bleed port may be a notch cut into a valve seat of the inlet port. The bleed port may provide a fluid path that is independent of a valve seat of the inlet port. The bleed port may be more or less restrictive than the exhaust port. Alternatively, the bleed port may be substantially as restrictive as the exhaust port, such as within ten percent and even within one percent.

A valve comprising a housing defining an interior chamber; an inlet port; an outlet port; an exhaust port; an actuator that selectively allows and prevents communication between the inlet port and outlet port; and a bleed port providing communication between the inlet port and the interior chamber regardless of the position of the actuator. The housing may be surrounded by an environment that is exposed to combustibles and classified as a hazardous environment according to an internationally recognized electric code, or standard. Even so, the valve may be rated as intrinsically safe according to the internationally recognized electric standard, regardless of the energy required to operate it. More specifically, the inlet port may be configured to receive an inert process control fluid from a supply line and communicate the process control fluid to the interior chamber. The outlet port may be configured to communicate the process control fluid between the interior chamber and a controlled line, such as to operate a process control valve or other device. The exhaust port may provide fluid communication between the interior chamber and the environment. The actuator may be a multi-layer piezoelectric element and may require more than fifty micro joules of energy to operate. The actuator may be located within the interior chamber and configured to selectively move between a first position and second position. For example, in the first position, the actuator may prevent communication of the process control fluid from the inlet port to the outlet port while simultaneously allowing communication of the process control fluid from the outlet port to the exhaust port through the interior chamber. In the second position, the actuator may allow communication of the process control fluid from the inlet port to the outlet port through the interior chamber. The bleed port may be a notch cut into a valve seat of the inlet port. The bleed port may be independent of a valve seat of the inlet port, and thereby provide a fluid path that is independent of the valve seat of the inlet port. The bleed port may be more or less restrictive than the exhaust port, or even substantially as restrictive as the exhaust port, thereby controlling a constant bleed of the process control fluid through the bleed port, interior chamber, outlet port, and exhaust port.

### BRIEF DESCRIPTION OF THE SEVERAL VIEWS OF THE DRAWINGS

FIG. 1 illustrates a particular embodiment of a valve utilizing certain aspects of the present inventions, with an actuator shown in a first position;

FIG. 2 illustrates the valve of FIG. 1, with the actuator shown in a second position;

FIGS. 3 and 4 illustrate close-up views of a particular embodiment of an input port of the valve of FIG. 1;

FIG. 5 illustrates a close-up view of another particular embodiment of an input port of the valve of FIG. 1; and

FIG. 6 illustrates a close-up view of still another particular embodiment of an input port of the valve of FIG. 1.

### DETAILED DESCRIPTION OF THE INVENTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time.

While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created a valve comprising a housing defining an interior chamber; an inlet port; an outlet port; an exhaust port; an actuator that selectively allows and prevents communication between the inlet port and outlet port; and a bleed port providing communication between the inlet port and the interior chamber regardless of the position of the actuator. The housing may be surrounded by an environment that is exposed to combustibles and classified as a hazardous environment according to an internationally recognized electric code, or standard. Even so, the valve may be rated as intrinsically safe according to the internationally recognized electric standard, regardless of the energy required to operate it, presuming that an inert process control fluid is used as a media to the supply line.

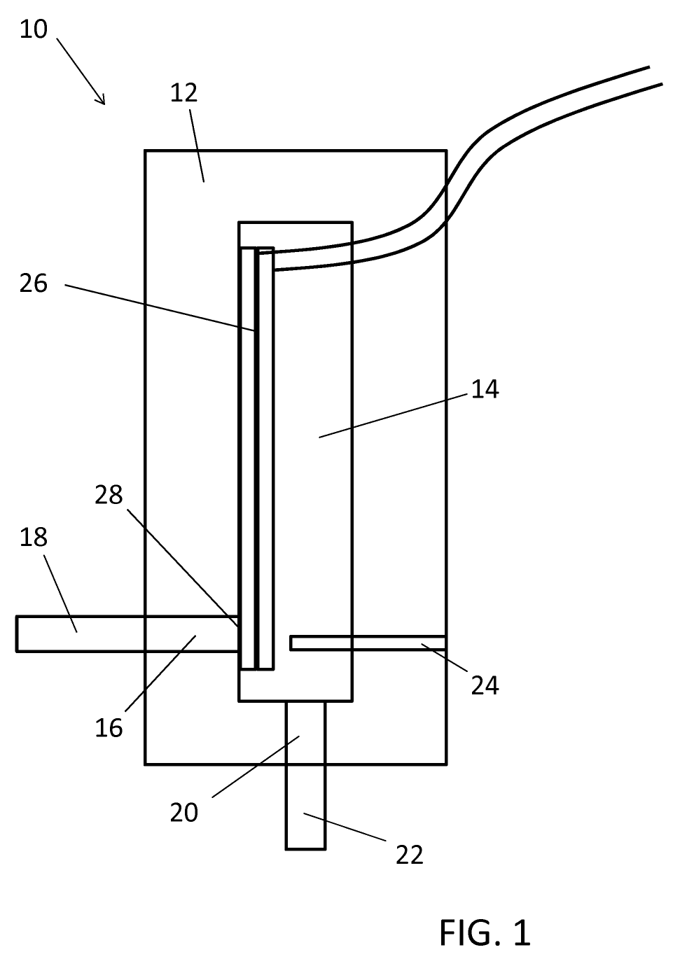

FIG. 1 is an illustration of a particular embodiment of a valve 10 utilizing certain aspects of the present inventions. The valve 10 includes a body or housing 12 that surrounds, or defines, and interior chamber 14. The valve 10 also includes an inlet port 16 that may be connected to a supply line 18 to receive process control fluid, such as an inert gas, therefrom in order to aid in the control of some industrial process. The valve 10 also includes an outlet port 20 that may be connected to a controlled line 22 to communicate the process control fluid to and from a process control valve or other device. The valve 10 also includes an exhaust port 24 that may or may not be connected to tubing or other plumbing.

The valve 10 functions by way of an actuator 26. For example, the actuator 26 may be a solenoid operated actuator or a piezoelectric element, such as a multi-layer piezoelectric element. In any case, when in a first position as shown in FIG. 1, the actuator 26 covers a valve seat 28 of the inlet port 16, thereby preventing communication of the process control fluid from the inlet port 16, into the interior chamber 14, and out of the outlet port 20. At the same time, it can be seen that the outlet port 20 is in communication with the interior chamber 14, and thus the exhaust valve 24. As a result, any force or pressure existing in the control line 22 may be vented, or exhausted through the outlet port 20, the interior chamber 14, and the exhaust port 24.

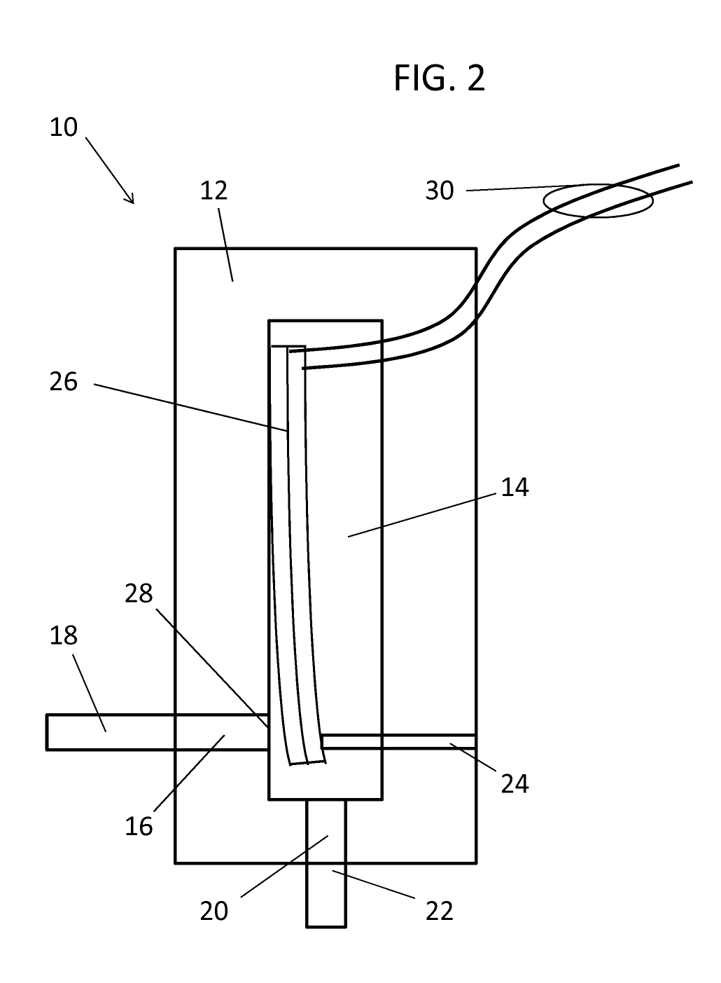

Referring also to FIG. 2, the actuator 26 may be operated, such as by energizing the electrical leads 30, and thereby shifted to a second position. In the second position, it can be seen that the actuator 26 has moved away from the valve seat 28 of the inlet port 16, thereby allowing communication of the process control fluid from the inlet port 16, into the interior chamber 14, and out of the outlet port 20. In this manner, the valve 10 selectively transfers force or pressure from the inlet port 16, to the outlet port 20. In this position, the actuator 26 may cover the exhaust port 24. It can be seen that the inlet port 16 is preferably in communication with the interior chamber 14 and outlet port 20.

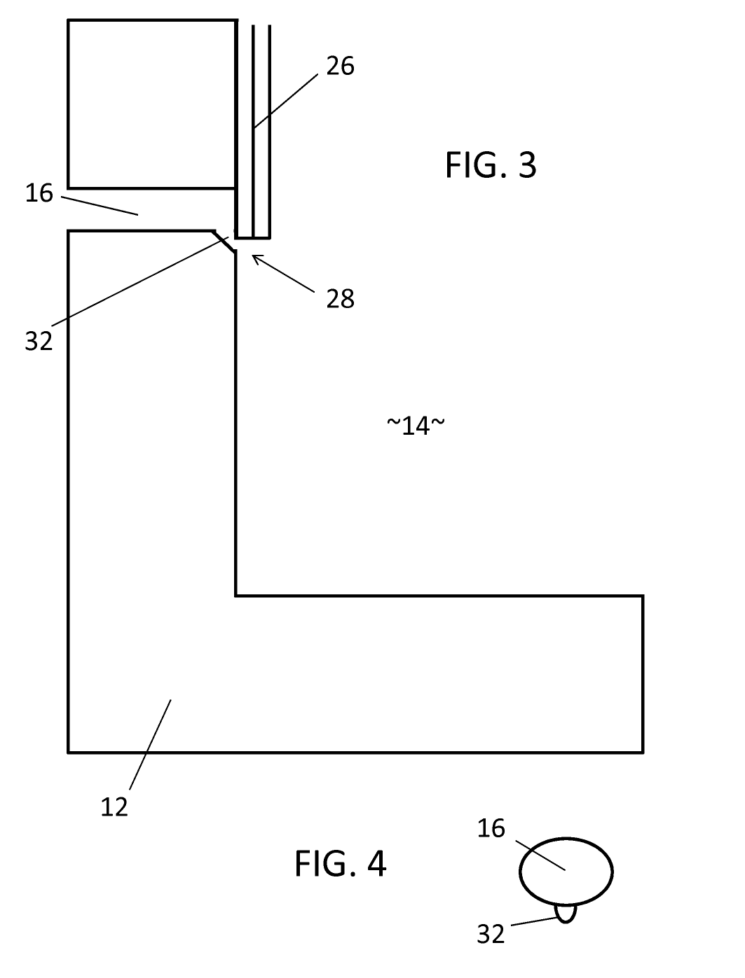

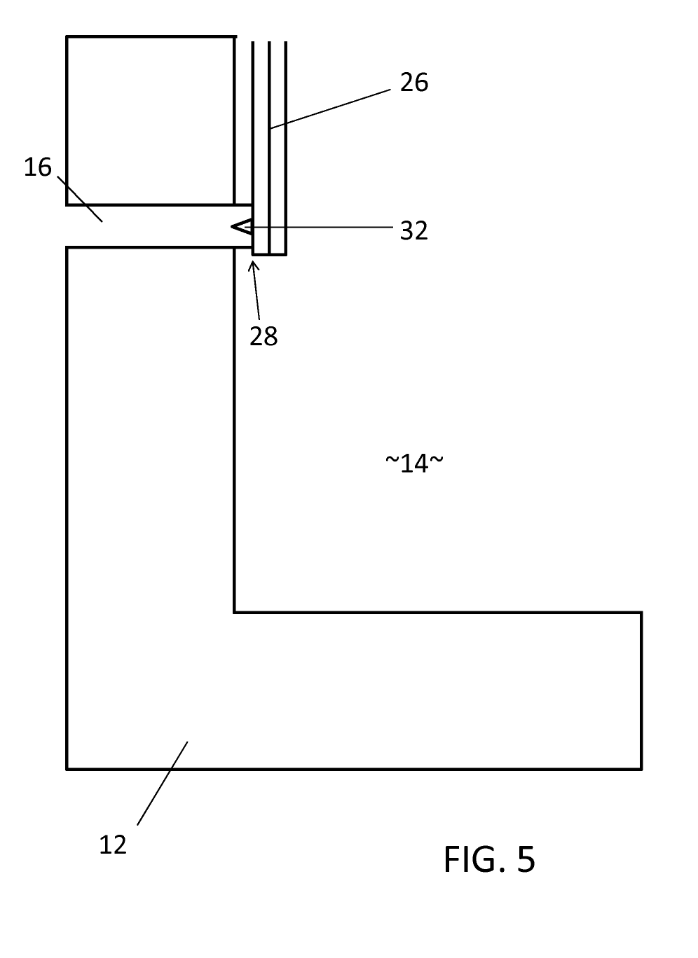

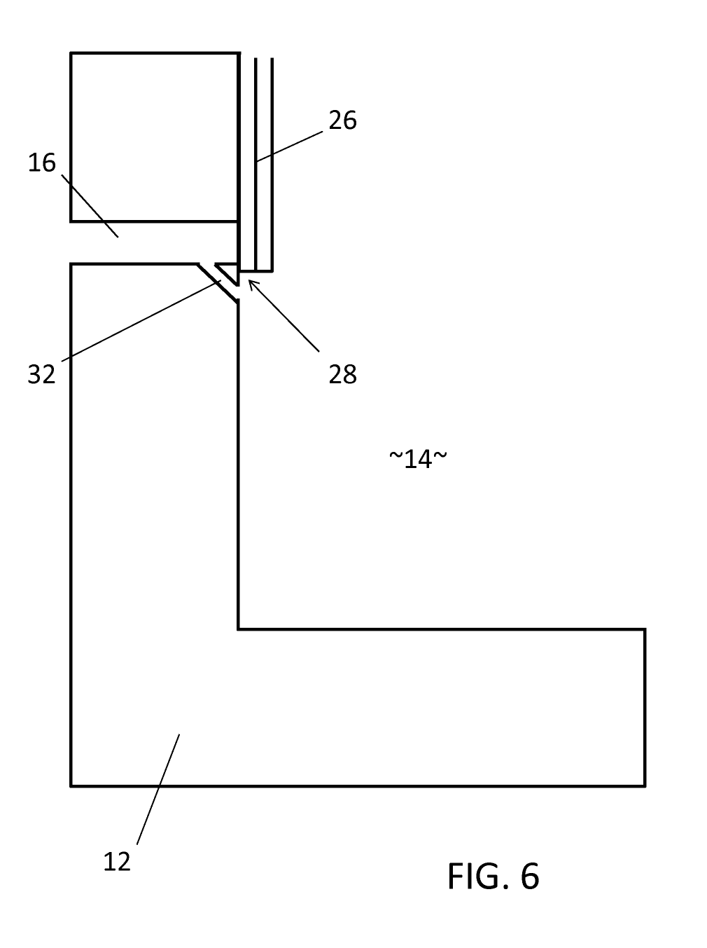

However, because the actuator 26 may requires more than fifty micro joules of energy to operate, and the valve of the present invention may be used in hazardous areas, such as those exposed to combustible gases, the present invention includes a means of constantly purging the interior chamber 14 with the inert process control gas or fluid. Referring also to FIG. 3, FIG. 4, FIG. 5, and FIG. 6, the valve 10 also preferably includes a bleed port 32 that supplies a constant purge of the process control fluid from the input port 16 into the interior chamber 14 and then out the exhaust port 24. As shown, the bleed port 32 may take many forms.

For example, as shown in FIG. 3 and FIG. 4, where the valve seat 28 sits flush with a wall of the interior chamber 14, the bleed port 32 may be an enlargement, or notch cut or otherwise formed into the valve seat 28 or mouth of the inlet port 16. Alternatively, as shown in FIG. 5, where the valve seat 28 protrudes into the interior chamber 14, the bleed port 32 may be a notch cut or otherwise formed into the valve seat 28 of the inlet port 16. In either case, the bleed port 32 allows some controlled portion of the process control fluid to escape the valve seat 28 and/or actuator 26, thereby purging the interior chamber 14 and actuator 26, regardless of the position of the actuator 26.

As shown in FIG. 6, the bleed port 32 may be completely independent of the valve seat 28 of the inlet port 16. For example, the bleed port 32 may bypass the valve seat 28 and directly communicate the process control fluid from the inlet port 16 to the interior chamber 14. The bleed port 32 could even bypass the inlet port 16 and directly communicate the supply line 18, or some other source of inert fluid or gas to the interior chamber 14. In either case, the bleed port 32 allows some controlled portion of the process control fluid to bypass the valve seat 28 and/or actuator 26, thereby purging the interior chamber 14 and actuator 26, regardless of the position of the actuator 26.

In this manner, the valve 10 of the present invention can be made safe for use in a hazardous environment, even where the actuator 26 requires more operating energy than might otherwise be allowed in such an environment. As such, the inventive features allow the valve 10 of the present invention to be rated as intrinsically safe according to internationally recognized electric codes and standards, such as the International Electrotechnical Commission (IEC) standard 60079, or IEC 60079-11.

It can be appreciated that the bleed port 32 and/or the exhaust port 24 may be sized, or otherwise configured, to provide a restriction in order to control the constant purge of the process control fluid from the supply line 18, through the bleed port 32, into the interior chamber 14, across the actuator 26, and out the exhaust port 24. In many applications, the exhaust port 24 is sized to adequately vent the discharge from the control line 22, to ensure proper operation of whatever device the valve 10 is installed to operate. Thus, in this case, the bleed port 32 would likely be more restrictive than the exhaust port 24.

However, in some applications, it may be desirable to maintain a positive pressure within the interior chamber 14. Thus, in this case, the bleed port 32 would likely be less restrictive than the exhaust port 24.

Finally, in some applications, it may be desirable to maintain a large purge volume through the interior chamber 14. Thus, in this case, the bleed port 32 would likely substantially as restrictive as the exhaust port 24. For example, the restriction presented by the bleed port 32 may be within ten percent, five percent, or even one percent of the restriction presented by the exhaust port 24.

Other and further embodiments utilizing one or more aspects of the inventions described above can be devised without departing from the spirit of Applicant's invention. For example, rather than bend as shown, the actuator 26 may shift and/or compress in operation of the valve 10. Additionally, rather than operate as a normally closed valve as described above, the valve 10 may operate as a normally open valve. Further, the various methods and embodiments of the present invention can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A valve comprising:
an inlet port;
an outlet port;
an interior chamber in a flow path between the inlet port and the outlet port;
an actuator within the interior chamber and configured to selectively move between a first position, wherein communication between the inlet port and the outlet port is prevented, and a second first position, wherein communication between the inlet port and the outlet port is allowed;
a bleed port providing fluid communication between the inlet port and the interior chamber regardless of the position of the actuator; and
an exhaust port providing fluid communication between the interior chamber and an environment surrounding the valve.

2. The valve as set forth in claim 1, wherein the actuator is a piezoelectric element.

3. The valve as set forth in claim 1, wherein the actuator is a multi-layer piezoelectric element that requires more than fifty micro joules of energy to operate.

4. The valve as set forth in claim 3, wherein the environment is classified as a hazardous environment.

5. The valve as set forth in claim 3, wherein the environment is exposed to combustibles.

6. The valve as set forth in claim 3, wherein the environment is classified as a hazardous environment according to an internationally recognized electric code and wherein the valve meets the codes requirements.

7. The valve as set forth in claim 3, wherein the valve is rated as intrinsically safe.

8. The valve as set forth in claim 3, wherein the valve is rated as intrinsically safe according to an internationally recognized electric code.

9. The valve as set forth in claim 1, wherein the bleed port is a notch cut into a valve seat of the inlet port.

10. The valve as set forth in claim 1, wherein the bleed port provides a fluid path that is independent of a valve seat of the inlet port.

11. The valve as set forth in claim 1, wherein the bleed port is more restrictive than the exhaust port.

12. The valve as set forth in claim 1, wherein the bleed port is less restrictive than the exhaust port.

13. The valve as set forth in claim 1, wherein the bleed port is substantially as restrictive as the exhaust port.

14. The valve as set forth in claim 1, wherein the bleed port provides a bleed restriction, the exhaust port provides an exhaust restriction, and the bleed restriction is within ten percent of the exhaust restriction.

15. The valve as set forth in claim 1, wherein the bleed port provides a bleed restriction, the exhaust port provides an exhaust restriction, and the bleed restriction is within one percent of the exhaust restriction.

16. A valve comprising:
a housing defining an interior chamber, the housing surrounded by an environment that is exposed to combustibles and classified as a hazardous environment according to an internationally recognized electric code;
an inlet port configured to receive an inert process control fluid from a supply line and communicate the process control fluid to the interior chamber;
an outlet port configured to communicate the process control fluid between the interior chamber and a controlled line;
an exhaust port providing fluid communication between the interior chamber and the environment;
a multi-layer piezoelectric element that requires more than fifty micro joules of energy to operate, the element located within the interior chamber and configured to selectively move between a first position, wherein communication of the process control fluid from the inlet port to the outlet port is prevented and communication of the process control fluid from the outlet port to the exhaust port through the interior chamber is allowed, and a second first position, wherein communication of the process control fluid from the inlet port to the outlet port through the interior chamber is allowed and communication of the process control fluid from the inlet port to the exhaust port through the interior chamber is prevented; and
a bleed port providing fluid communication between the inlet port and the interior chamber regardless of the position of the actuator,
wherein the valve is rated as intrinsically safe according to the internationally recognized electric code.

17. The valve as set forth in claim 16, wherein the bleed port is a notch cut into a valve seat of the inlet port.

18. The valve as set forth in claim 16, wherein the bleed port provides a fluid path that is independent of a valve seat of the inlet port.

19. The valve as set forth in claim 1, wherein the bleed port is more restrictive than the exhaust port.

20. The valve as set forth in claim 1, wherein the bleed port is less restrictive than the exhaust port.
